(19) United States
(12) Patent Application Publication
(10) Pub. No.: US 2015/0009782 A1
(43) Pub. Date: Jan. 8, 2015

(54) ULTRASOUND PROBE AND METHOD OF OPERATING AN ULTRASOUND PROBE

(71) Applicant: INTELLIGENDT SYSTEMS & SERVICES GMBH, ERLANGEN (DE)

(72) Inventors: GUENTER ENGL, ERLANGEN (DE); RAINER MEIER, ERLANGEN (DE)

(21) Appl. No.: 14/492,105

(22) Filed: Sep. 22, 2014

Related U.S. Application Data
(63) Continuation of application No. PCT/EP2013/055859, filed on Mar. 20, 2013.

(30) Foreign Application Priority Data
Mar. 20, 2012 (DE) 102012204444.2
Oct. 26, 2012 (DE) 202012104119.7

(51) Int. Cl. G10K 11/18

(52) U.S. Cl. CPC G10K 11/18
USPC 367/189

(57) ABSTRACT

An ultrasound probe contains an ultrasound transducer arrangement that is formed with a plurality of transducer elements. The transducer elements are arranged next to one another in a row and they can be controlled with a time delay. The transmitting/receiving surfaces of the transducer elements are inclined relative to one another such that the angle of inclination between the transmitting/receiving surfaces of two transducer elements increases with the number of transducer elements located between the transducer elements. At least two of the incremental angles of inclination between each pair of adjacent transducer elements are different.

### CROSS-REFERENCE TO RELATED APPLICATION

This application is a continuation, under 35 U.S.C. §120, of copending international application PCT/EP2013/055859, filed Mar. 20, 2013, which designated the United States; this application also claims the priority, under 35 U.S.C. §119, of German patent application DE 20 2012 104 119.7, filed Oct. 26, 2012, and German patent application DE 10 2012 204 444.2, filed Mar. 20, 2012; the prior applications are herewith incorporated by reference in their entirety.

### BACKGROUND OF THE INVENTION

1. Field of the Invention

The invention relates to an ultrasound probe having an ultrasound transducer arrangement which comprises a plurality of transducer elements that are arranged in a row next to one another and that can be controlled with a time delay.

In the case of such an ultrasound transducer arrangement, also referred to as a transducer array or a phased array, both the insonation angle into a test specimen and the depth of focus can be varied by controlling the transducer elements with time delay or temporal delay. It is thereby possible to activate a larger range of search angles and thereby to detect eventual defects in larger regions of the test specimen given a stationary ultrasound probe. As a rule, the ultrasound transducer arrangements are so called line arrays in the case of which a conventional piezoceramic transducer is subdivided into small mutually acoustically separated transducer elements, the dividing cutting direction being transverse to the insonation plane in which an angular swivel is to take place. In order to attain a homogeneous sound beam and a large angular range, the transducer elements obtained by the subdivision may not exceed a dimension of the order of magnitude of the wavelength in the insonation plane. In order to attain a high resolution and a high signal-to-noise ratio, most applications require the production of a sound beam with a sufficiently low divergence, and this requires larger dimensions of the entire ultrasound transducer arrangement. This signifies a large number of individual transducer elements, sixteen or more as a rule, which are simultaneously controlled or jointly controlled with time delay. The large number of transducer elements demands a corresponding number of connecting cables, connections and, particularly regarding internal inspection, of hollow shafts which are scanned by a helical movement of the probe, a corresponding number of slip-ring contacts, and a corresponding number of electronic channels in the test unit. That is, the technical outlay is considerable.

### SUMMARY OF THE INVENTION

It is accordingly an object of the invention to provide a ultrasound probe and a related method which overcome the disadvantages of the heretofore-known devices of this general type and which provide for an ultrasound probe having an ultrasound transducer arrangement with a plurality of transducer elements which are arranged in a row next to one another and can be controlled with a time delay, with the aid of which ultrasound probe it is possible, given a reduced technical outlay, to cover a large swivel range with high spatial resolution in a workpiece.

With the above and other objects in view there is provided, in accordance with the invention, an ultrasound probe, comprising:
an ultrasound transducer arrangement having a plurality of transducer elements arranged in a row next to one another and controllable simultaneously or with a time delay relative to one another;
said plurality of transducer elements being inclined relative to one another, with respective transmitting/receiving surfaces thereof facing in the same direction among one another and an angle of inclination between the transmitting/receiving surfaces of two of said transducer elements increasing with a number of transducer elements located between said two transducer elements, and wherein at least two incremental angles of inclination between respectively adjacent transducer elements differ from one another.

That is, the objects of the invention are achieved with a novel ultrasound probe that includes an ultrasound transducer arrangement having a plurality of transducer elements, which are arranged in a row next to one another, can be controlled with a time delay, and are arranged inclined to one another in such a way that their transmitting/receiving surfaces face one another and the angle of inclination between the transmitting/receiving surface of two transducer elements increases with the number of the transducer elements located between them. Furthermore, the transducer elements are arranged in such a way that at least two of the incremental angles of inclination between respectively adjacent transducer elements differ from one another.

In other words: the transmitting/receiving surfaces of the transducer elements arranged next to one another are located not in one plane, for example on the inclined face of a common wedge but, for example, on facets, facets situated next to one another respectively being inclined with one another at a prescribed angle. The prescribed angle can be freely chosen in this case and adapted to the respective application or the component to be tested. The result of this is, for example, an ultrasound arrangement in which the facets or the transducer elements arranged thereon are arranged not along a circular arc, but along a curved shape deviating from a circular arc, or on a precursor body formed in such a shape. For example, the incremental angle of inclination can be staggered in this case so that it increases or decreases starting from the edge of the ultrasound transducer arrangement. In comparison to a circular geometry, it is thereby possible to achieve a lesser overall height of the ultrasound probe.

Here, incremental angle of inclination is understood to mean the difference in the angle of inclination between respectively adjacent transducer elements. In other words: the incremental angle of inclination is the angle at which respectively adjacent transducer elements are inclined to one another, or the angle which is enclosed between them by the transmitting/receiving surfaces of the respectively adjacent transducer elements. According to the invention, at least two incremental angles of inclination of respectively adjacent transducer elements differ from one another or are of different size. In other words: the incremental angles of inclination are not all the same size. The individual sizes of the incremental angles of inclination are chosen in this case so as, in particular, to cut out an angle for which a longitudinal wave would be propagated in the workpiece parallel to the surface (first critical angle).

In comparison to an ultrasound transducer arrangement according to the prior art, the different angular positioning of the transmitting/receiving surfaces of the transducer elements relative to a coupling surface enables the same swiveling angular range to be detected with a smaller number of transducer elements, for example approximately five to eight transducer elements. Even given a common control of at least two adjacent transducer elements, a satisfactorily narrow sound beam with a correspondingly high signal-to-noise ratio results according to the fact that given such a smaller number of transducer elements, the width of an individual transducer element is significantly greater in conjunction with the same total width of the ultrasound transducer arrangement, preferably greater than 1.5 times the wavelength of the ultrasound signal produced by a transducer element than in the case of a conventional linear ultrasound transducer arrangement. Moreover, yet a further swivel of the insonation angle can be attained by controlling adjacent transducer elements with time delay. It is true that said swivel range is physically limited owing to the fact that only a few, preferably two to three, transducer elements are controlled as a group. The progressive combination of two to three transducer elements can, together with their different insonation angles, which are pre-cut by the respective inclination and therefore do not result from control by time delay, and supplemented by the swiveling angular range within the respective combination of said transducer elements, be used to sweep a total swiveling angular range which is comparable to that of a conventional linear transducer array with many narrow transducer elements in a plane. Consequently, the technical outlay in the cabling of the ultrasound probe is significantly reduced. This is particularly advantageous in the internal testing of shafts with a longitudinal bore which requires a rotational movement of the linear ultrasound transducer arrangement about the longitudinal axis of the shaft and, accordingly, a number of slip rings corresponding to the number of the channels.

A further possibility of the ultrasound probe according to the invention also consists in that the depth of focus, that is to say the distance between the focus and the surface of the test specimen, can be varied by appropriate time delays given control of three or more transducer elements.

As an alternative to the joint control of two adjacent transducer elements with time delay, it is also possible to swivel the insonation angle of the ultrasound signal into a workpiece by joint control with time delay of at least two not directly adjacent transducer elements. In particular, such a control can be used to detect faults which, for example, are not retroreflected in the insonation direction. It is particularly advantageous in this case to configure the control so that one transducer element or one group of transducer elements is operated in transmit mode, and another transducer element or another group of transducer elements operates in receive mode.

Moreover, the ultrasound emitted by an individual transducer element has a sufficiently large opening angle of the sound beam which is advantageous, or required, for the reconstructing method, referred to as synthetic aperture focusing technique (SAFT), for example, for analyzing fault locations.

In one advantageous embodiment of the ultrasound probe, the transducer elements are arranged on the tooth flanks of a sawtooth precursor body. The individual tooth flanks are checked in this case at a different angle relative to the coupling surface of the ultrasound probe. In other words: the individual tooth flanks of the precursor body, consisting of plastic, for example, are respectively configured according to the angle which the respective transducer element is to have relative to the common coupling surface. The precursor body thus itself already has the shape adapted to the arrangement of the individual transducer elements, and the transducer elements can subsequently be applied to the individual tooth flanks with a low outlay.

It is, furthermore, advantageous when the individual transducer elements are arranged on a precursor body in such a way that a precursor distance respectively resulting between the transmitting/receiving surface of the transducer elements and the coupling surface of the precursor body is the same size for all the transducer elements. The test sensitivity is the same for each transducer element in this case. In other words: the individual transducer elements are arranged at such a distance from the coupling surface that the precursor distance is the same length for each transducer element. Here, the precursor distance is understood as the length of the normal through the midpoint of the respective transmitting/receiving surface of a transducer element and standing thereon at right angles reaching as far as the coupling surface.

It can likewise be advantageous when the distance from the midpoint of the transmitting/receiving surface perpendicular to the coupling surface is held constant. In other words: the transducer elements are arranged on the precursor body in such a way that a distance resulting between the midpoint of the transmitting/receiving surface of the transducer elements and perpendicular to the coupling surface of the precursor body is the same size for all the transducer elements. This significantly facilitates the algorithms for calculating the time delay in the control of the individual transducer elements.

In the case of such a sawtooth arrangement, the incremental angle of inclination can, for example, likewise be staggered so that it increases or decreases starting from the edge of the ultrasound transducer arrangement. Said ultrasound transducer arrangement leads to a yet lower overall height, and has the advantage that the interfering repetition echoes otherwise appearing in an ultrasound probe are very largely minimized.

The individual tooth flanks can be designed both regularly and irregularly, that is to say, for the sake of example, to be of various widths or of different lengths. It is thereby possible to make use of transducer elements of different sizes and various shapes, as a result of which the sound field produced thereby can be further varied.

Other features which are considered as characteristic for the invention are set forth in the appended claims.

Although the invention is illustrated and described herein as embodied in an ultrasound probe and a method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic sketch of a longitudinal section through a first embodiment of an ultrasound probe in accordance with the invention;

FIG. 2 is a schematic illustration of a sound beam respectively emitted from two adjacently arranged transducer elements, and the sound beam resulting from superimposition;

FIG. 3 shows a second embodiment of an ultrasound probe in accordance with the invention, again in a schematic sketch in longitudinal section; and

FIG. 4 is a schematic of a temporally delayed control of an ultrasound transducer arrangement in accordance with the invention.

### DETAILED DESCRIPTION OF THE INVENTION

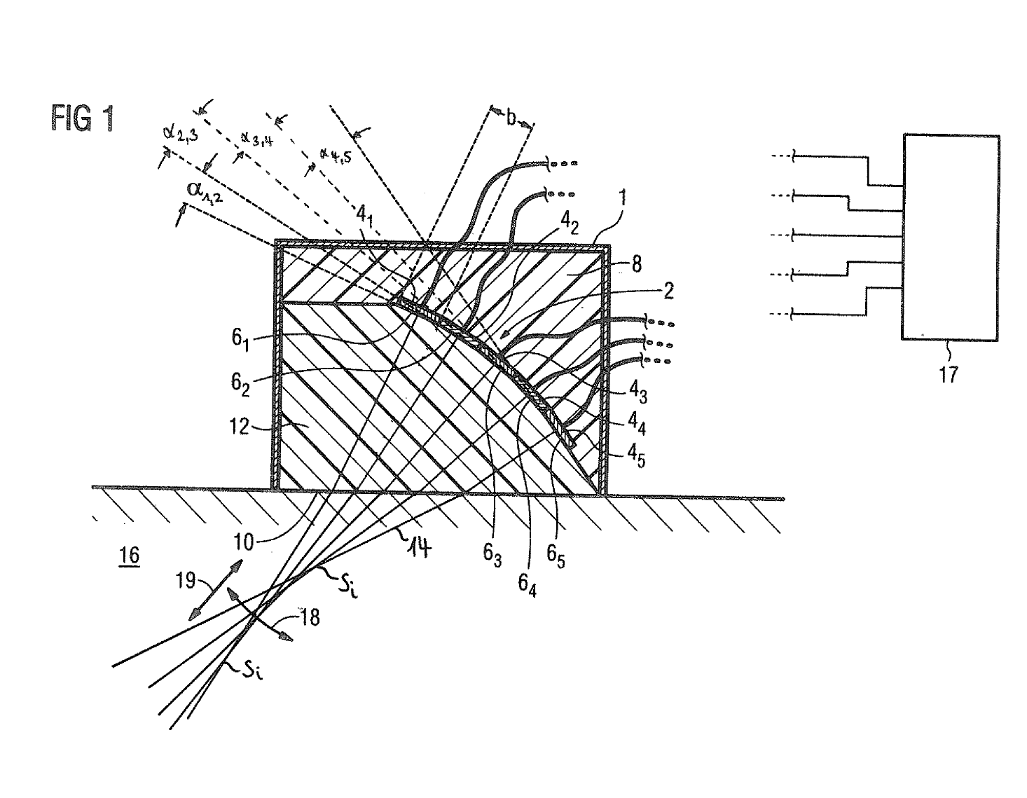

Referring now to the figures of the drawing in detail and first, particularly, to FIG. 1 thereof, there is shown an ultrasound probe that comprises a housing 1 in which there is arranged an ultrasound transducer arrangement 2. The transducer arrangement 2 comprises a plurality of piezoceramic transducer elements 4ᵢ—illustrated with five transducer elements 4₁ to 4₅ in FIG. 1—which are arranged in a row next to one another and which can be controlled with a time delay. The transducer elements 4ᵢ are arranged next to one another in such a way that transmitting/receiving surfaces 6ᵢ, 6ⱼ of respectively adjacent transducer elements 4ᵢ, 4ᵢ₊₁ are arranged inclined to one another at an incremental angle of inclination α_{i,i+1} which is not the same size for all adjacent transducer elements 4ᵢ, 4ᵢ₊₁. The transducer elements 4ᵢ are, that is to say, not arranged along a circular arc, but rather along a curved line deviating from a circular arc.

In accordance with FIG. 1, all the incremental angles of inclination differ from one another, that is to say α_{i,i+1}≠α_{j,j+1} for all i≠j or α_{1,2}≠α_{2,3}≠α_{3,4}≠α_{4,5}. The incremental angle of inclination α_{i,i+1} can, by way of example, be staggered in this case so that it increases or decreases starting from the edge of the ultrasound transducer arrangement 2. Consequently, the angle of inclination α_{1,j} increases between a transducer element 4₁ located at the end of the row and another transducer element 4ⱼ of the row with the number j−2 of the transducer elements located therebetween. In other words: the transmitting/receiving surfaces 6ᵢ are arranged inclined to one another in such a way that the angle of inclination α_{i,j} increases between the transmitting/receiving surface 6ᵢ of two transducer elements 4ᵢ, 4ⱼ with the number of transducer elements located therebetween.

In the case of the testing of shafts made from steel that start from a bore, typical incremental angles of inclination α_{i,i+1} lie, for example, in a range between 1.5° and 10°. An ultrasound transducer arrangement with incremental angles of inclination of α_{1,2}=3.2°, α_{2,3}=3.4°, α_{3,4}=4.8° and α_{4,5}=2.5° has proved itself in the case of, for example, the internal testing of a hollow shaft. Also conceivable would be an ultrasound transducer arrangement whose incremental angles of inclination do not all deviate from one another, that is to say, for example, α_{1,2}=3.2°, α_{2,3}=3.4°, α_{3,4}=4.8° and α_{4,5}=α_{1,2}=3.2°.

The transducer elements 4ᵢ are inclined to one another in such a way that their transmitting/receiving surfaces 6ᵢ face one another so that the normals perpendicular to the transmitting/receiving surface 6ᵢ intersect in the space facing the transmitting/receiving surfaces 6ᵢ in which the sound beams transmitted by the transducer elements 4ᵢ propagate. The width b of the transducer elements 4ᵢ is in this case at least equal to 1.5 times, preferably greater than four times the wavelength of the ultrasound signal which is produced by them and introduced into the test specimen by insonation.

The transducer elements 4ᵢ are embedded in a sound deadening backing 8, there being located between a coupling surface 10 of the ultrasound probe and the transmitting/receiving surfaces 6ᵢ, 6ⱼ a precursor body 12 made from plastic, which is formed in accordance with the incremental angles of inclination α_{i,i+1}, for example by a faceted wedge.

Illustrated in FIG. 1 are the center axes 14 of the sound beams respectively emitted by the transducer elements 4ᵢ, which intersect in a workpiece 16 to be tested, at respectively different intersection points Sᵢ when angular positioning of the transducer elements 4ᵢ relative to the coupling surface 10, width b of the transducer elements 4ᵢ and angles of inclination α_{i,i+1} as well as length of the precursor distance 12, which is defined by the precursor volume and depends on the position of the transducer element 4, or of the workpiece 16 are adapted to one another. It is thereby possible to achieve various depths of focus and to cover a large depth range.

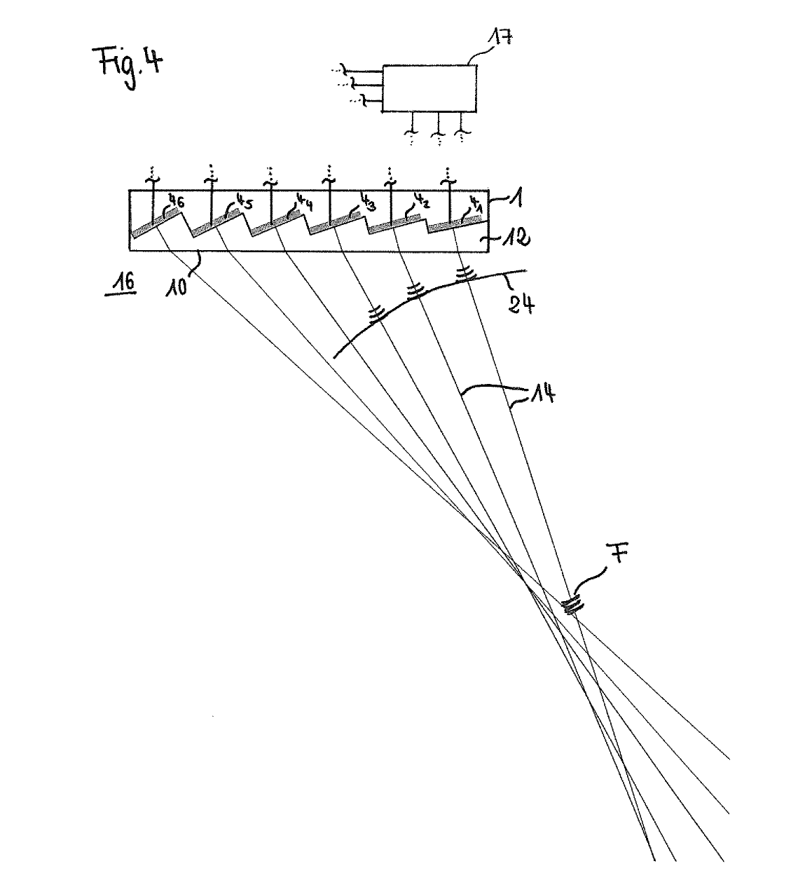

Provided in order to control the transducer elements 4ᵢ is a control and evaluation device 17 which, with the aid of joint control with a simultaneous or time-delayed activation of at least two or more adjacent transducer elements 4ᵢ, can be used to swivel the insonation angle into the workpiece 16 in a limited angular range, as indicated in FIG. 1 by the double arrow 18. The insonation angle can likewise also be swiveled by means of joint control with a time delay of two not directly adjacent transducer elements 4ᵢ, 4ᵢ₊ⱼ. In the case of such a control, it is possible, for example, for the transducer element 4ᵢ to operate as transmitter, and for the transducer element 4ᵢ₊ⱼ to operate as receiver. In addition, it is possible furthermore to vary the depth of focus in the workpiece 16 by means of suitable time delay patterns when three or more adjacent transducer elements 4ᵢ are jointly controlled. This is illustrated in FIG. 1 by the double arrow 19. The principle of the temporally delayed control of the transducer elements 4ᵢ is additionally illustrated in FIG. 4.

Moreover, it is possible to use the control and evaluation device 17 to control the transducer elements 4ᵢ individually and, by employing the wide sound beams respectively emitted by the individual transducer elements, to undertake an evaluation of the received echo signals by using a method denoted as SAFT.

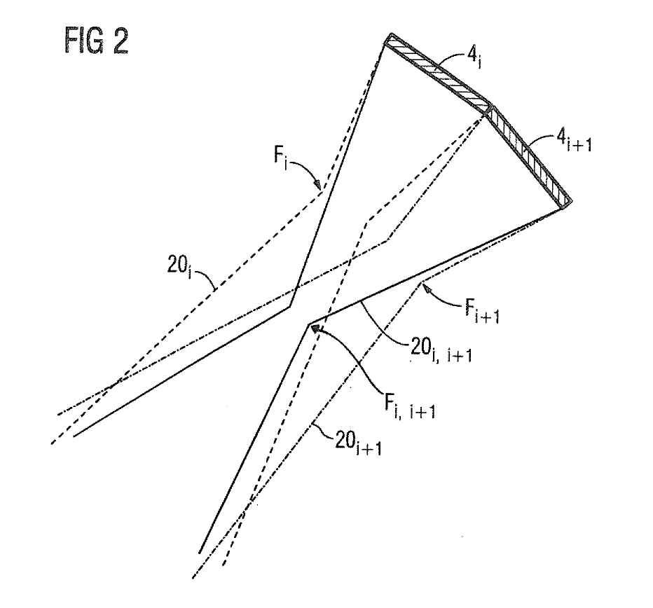

The sound beams 20ᵢ, 20ᵢ₊₁ of two transducer elements 4ᵢ, 4ᵢ₊₁ arranged next to one another are illustrated in FIG. 2 by continuous lines or in a dashed fashion without refraction at an interface. The figure illustrates how simultaneous superimposition of said two sound beams 20ᵢ, 20ᵢ₊₁ produces a narrower sound beam 20_{i,i+1} whose focus F_{i,i+1} is narrower than the foci Fᵢ, Fᵢ₊₁ of the sound beams 20ᵢ, 20ᵢ₊₁ and further removed from the transducer elements 4ᵢ, 4ᵢ₊₁.

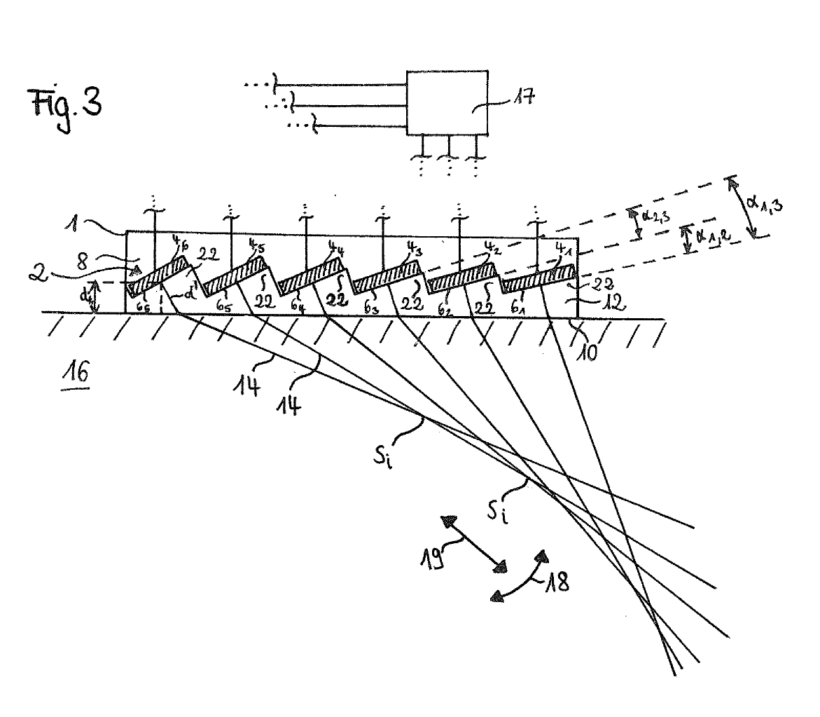

FIG. 3 shows a second embodiment of an ultrasound probe in accordance with the invention comprising an ultrasound transducer arrangement 2 whose transducer elements 4ᵢ, here six transducer elements 4₁ to 4₆, are arranged in a row next to one another on the tooth flanks 22 of a sawtooth precursor body 12.

In accordance with FIG. 3, proceeding perpendicularly from a midpoint of the transmitting/receiving surface 6ᵢ, the individual transducer elements 4ᵢ are respectively arranged at a distance dᵢ from the coupling surface 10 such that the precursor distance d′, that is to say the distance in the direction of a normal to the coupling distance 10 erected on the transmitting/receiving surface 6ᵢ, is of the same length for each transducer element 4ᵢ, and the test sensitivity is therefore the same for each transducer element 4ᵢ.

However, it is likewise possible in principle to arrange the individual transducer elements 4ᵢ on the precursor body 12 in such a way that the distance dᵢ between the midpoint of the transmitting/receiving surface 6ᵢ of the transducer elements 4ᵢ and perpendicular to the coupling surface 10 of the precursor body 12 is the same size for all the transducer elements 4ᵢ. A constant distance dᵢ facilitates simple control of the transducer elements 4ᵢ by the control device 17 and the control software thereof since, in comparison to a linear array, there is no need for software adaptation.

The tooth flanks 22 of the precursor body 12 are set at different angles relative to the coupling surface 10, and so the transmitting/receiving surfaces 6₁ to 6₆ of the transducer elements 4₁ to 4₆ are inclined to one another, the incremental angle of inclination α_{i,i+1} between respectively adjacent transducer elements being of different size. In accordance with FIG. 3, the incremental angle of inclination α_{2,3} is larger than the incremental angle of inclination α_{1,2}. The sawteeth or tooth flanks 22 of the precursor body 12 thus have an irregular shape, and so the transmitting and receiving surfaces 6₁ to 6₆ of the individual transducer elements 4₁ to 4₆ are oriented at a different angle relative to the coupling surface 10.

In this exemplary embodiment as well, the six transducer elements 4ᵢ are inclined to one another such that the angle of inclination α_{i,j} between the transmitting/receiving surface 6ᵢ, 6ⱼ of two transducer elements increases with the number of the transducer elements 4ᵢ located therebetween. The angle of inclination α_{1,3} is therefore correspondingly larger than the incremental angle of inclination α_{1,2}. In other words: the angles at which the tooth flanks 22, and thus the transmitting/receiving surfaces 6ᵢ, are set relative to the coupling surface 10 decrease in the insonation direction. That is to say, the transducer elements 4ᵢ are arranged in a flatter fashion in the insonation direction, and so the transducer element 4ᵢ is oriented at the lowest setting angle relative to the coupling surface 10. It is thereby possible, for example, to achieve focusing of the individual sound beams at various points of intersection Sᵢ.

Furthermore, the device 2 comprises a control device 17 for controlling the transducer elements 4ᵢ with a time delay. The transducer elements 4ᵢ arranged next to one another are temporally excited one after another in order to swivel the insonation angle into the workpiece 16 electronically, or to focus the ultrasound waves in addition. In this case, both individual and all transducer elements 4ᵢ, or a group of transducer elements 4ᵢ, for example two adjacent transducer elements 4ᵢ, 4ᵢ₊₁ can be operated jointly. Also shown in FIG. 3 are the center axes 14 of the sound beams respectively emitted by a transducer element 4ᵢ, and the points of intersection Sᵢ at which respective center longitudinal axes 14 intersect.

As already mentioned above, it is illustrated in FIG. 4 how the ultrasound transducer arrangement or the individual transducer elements 4ᵢ are controlled in order to obtain a desired insonation angle and a desired focus F. In accordance with FIG. 4, the transducer elements 4₁ to 4₆ are temporally controlled with a delay in order, on the one hand, to swivel the insonation angle and, on the other hand, to set a desired depth of focus. A wavefront 24 which results in a focusing of the ultrasound waves emitted by the transducer elements 4₁, 4₂, 4₃ with a time delay relative to one another at the focus F is illustrated in FIG. 4. A larger swivel angle range can be covered using an ultrasound probe in accordance with the invention with a small number of transducer elements given a suitable temporal delay in the ultrasound pulses.

1. An ultrasound probe, comprising:
an ultrasound transducer arrangement having a plurality of transducer elements arranged in a row next to one another and controllable with a time delay relative to one another;
said plurality of transducer elements being inclined relative to one another, with respective transmitting/receiving surfaces thereof facing toward one another and an angle of inclination between the transmitting/receiving surfaces of two of said transducer elements increasing with a number of transducer elements located between said two transducer elements, and wherein at least two incremental angles of inclination between respectively adjacent transducer elements differ from one another.

2. The ultrasound probe according to claim 1, wherein all of the incremental angles of inclination between respectively adjacent transducer elements differ from one another.

3. The ultrasound probe according to claim 1, wherein said transducer elements have a given width, and the given width is greater than 1.5 times a wavelength of an ultrasound signal produced by said transducer elements.

4. The ultrasound probe according to claim 1, which comprises a precursor body formed in a sawtooth pattern, and wherein said transducer elements are arranged on tooth flanks of said sawtooth-shaped precursor body.

5. The ultrasound probe according to claim 1, which comprises a precursor body having a coupling surface, and wherein said transducer elements are arranged on said precursor body such that a precursor distance respectively defined between the transmitting/receiving surface of said transducer elements and said coupling surface of said precursor body has an equal value for all said transducer elements.

6. The ultrasound probe according to claim 1, which comprises a precursor body having a coupling surface and wherein said transducer elements are arranged on said precursor body such that a distance from a midpoint of said transmitting/receiving surface of said transducer elements and said coupling surface of said precursor body, along a line perpendicular to said coupling surface, has an equal value for all said transducer elements.

7. A method of operating an ultrasound probe, the method comprising:
providing an ultrasound probe according to claim 1 and placing the ultrasound probe on a workpiece;
swiveling an insonation angle of an ultrasound signal into the workpiece by joint control of at least two transducer elements, with a simultaneous or time-delayed activation between at least two transducer elements.

8. The method according to claim 7, which comprises jointly controlling with a simultaneous or time-delayed activation between at least two adjacent transducer elements.

9. The method according to claim 8, which comprises varying a focal distance of an ultrasound signal from a surface of the workpiece by joint control with a simultaneous or time-delayed activation between at least three adjacent transducer elements.

10. The method according to claim 7, which comprises jointly controlling with a simultaneous or time-delayed activation between at least two transducer elements that are not directly adjacent one another.

11. The method according to claim 7, which comprises controlling the two not directly adjacent transducer elements with one transducer element being operated in transmit mode while operating the respectively other transducer element in receive mode.

12. The method according to claim 7, which comprises operating the ultrasound probe according to claim 1 by individually driving the transducer elements and evaluating received echo signals using a synthetic aperture focusing technique (SAFT).
